(19) United States
(12) Patent Application Publication
(10) Pub. No.: US 2015/0186832 A1
(43) Pub. Date: Jul. 2, 2015

(54) METHOD AND SYSTEM FOR FACILITATING LOCATION INTELLIGENCE IN ELECTRONIC TRANSACTIONS

(71) Applicant: Pitney Bowes Software Inc., Danbury, CT (US)

(72) Inventor: Vedat Kaplan, Fredrick, MD (US)

(73) Assignee: Pitney Bowes Software Inc., Danbury, CT (US)

(21) Appl. No.: 14/144,982

(22) Filed: Dec. 31, 2013

(51) Int. Cl. G06Q 10/08; H04W 64/00; G06Q 30/06

(52) U.S. Cl. CPC G06Q 10/083; G06Q 30/0635; H04W 64/00

(57) ABSTRACT

A method and system facilitate and enhance electronic transactions performed over a computer network. A server transmits transaction information to a remote device having location detection capability, such as GPS. The transmitted information includes a message prompting a user to enter the user's location information. This prompt is preferably in the form of a selectable option for the user to automatically populate the location information from the device's location detection capability for the transaction. Upon selection of the option by the user, location information is sent to the server from the remote device. Received coordinates are reverse geocoded to identify at least one matching address for the coordinates. The at least one matching address is then entered into a transaction database as an address relevant to the transaction.

### TECHNICAL FIELD

The improvements described herein relate to use of location intelligence to enhance users' electronic commerce experiences, particularly on mobile devices.

### BACKGROUND OF THE INVENTION

Advances in telecommunications technology have enabled faster and more accurate location of users carrying mobile devices. Global Positioning Systems (GPS) receivers are commonly used on smart phones and other mobile devices to gather location data for use on the mobile device. GPS utilizes signals transmitted by a number of in-view satellites to determine the location of a GPS antenna which is connected to a receiver.

A location determined by GPS is typically expressed in terms of a geocode, such as latitude and longitude coordinates. A geocode is a specification of a position using a suitable coordinate system at a granularity sufficient for a particular application. A geocode may provide spatial information in a form other than specifying the longitude and the latitude. Other examples of geocodes include postal centroids that are associated with areas sharing a common zip code. A centroid is a geographic center of an entire area, region, boundary, etc, for which the specific geographic area covers. A familiar example is the association between a centroid and a postal code, such as the ZIP codes defined and used by the United States Postal Service.

Reverse geocoding systems receive a physical location as input and return a corresponding georeferenced data item, such as an address. Physical location input is usually provided in the form of latitude and longitude. Datasets for reverse geocoding may include street segment centerlines, each attributed with ranges of addresses, or single-parcel polygons that contain one street address attribute for each polygon. Individual addresses can be calculated from the street segments by interpolation. Addresses are computed in parcel datasets using standard point-in-polygon processes. Street intersections are derived from street segments that abut or cross. Reverse geocoding datasets may also include point or parcel data which are known to give more accurate results than street segment centerline datasets since they are directed to the discrete addresses present on the street.

### SUMMARY OF THE INVENTION

To facilitate and enhance electronic transactions performed over a computer network, a new system and method are proposed for computer servers that process electronic transactions, The server transmits transaction information over a network to a remote device. In the preferred case, the remote device has location detection capability, such as a GPS receiver. The transmitted information includes a message prompting a user to enter the user's location information. This prompt is preferably in the form of a selectable option for the user to automatically populate the location information from the device's location detection capability for the transaction.

Upon selection of the automatic location option by the user, location information is sent to the server from the remote device. Received coordinates are reverse geocoded to identify at least one matching address for the coordinates. The at least one matching address is then entered into a transaction database as an address relevant to the transaction. That address then may be used for the location of the delivery of an item or as the location of services to be performed depending on the nature of the electronic transaction.

In a preferred embodiment, prior to entering a matching address in the transaction database, the user is presented with a matching addresses which the user can then confirm as correct. In a case with multiple potential matches, the user can be asked to pick which, if any, of the marches are correct. A map may also be provided to assist in the verification process. A verified address can then be added into the transaction database. A verified address can also be used to enhance and update an existing general purpose geographic database

In a further preferred embodiment, the address derived from the method described above is used to update a general profile for the user, whereby such address may be used in connection with other transactions or communications with the user.

### BRIEF DESCRIPTION OF THE DRAWINGS

FIG. 1 shows the overall system for location enhanced electronic commerce.

FIG. 2 shows a preferred embodiment for display information transmitted to the mobile device from the transaction server.

FIG. 3 shows the process steps for using the enhanced system.

### DETAILED DESCRIPTION

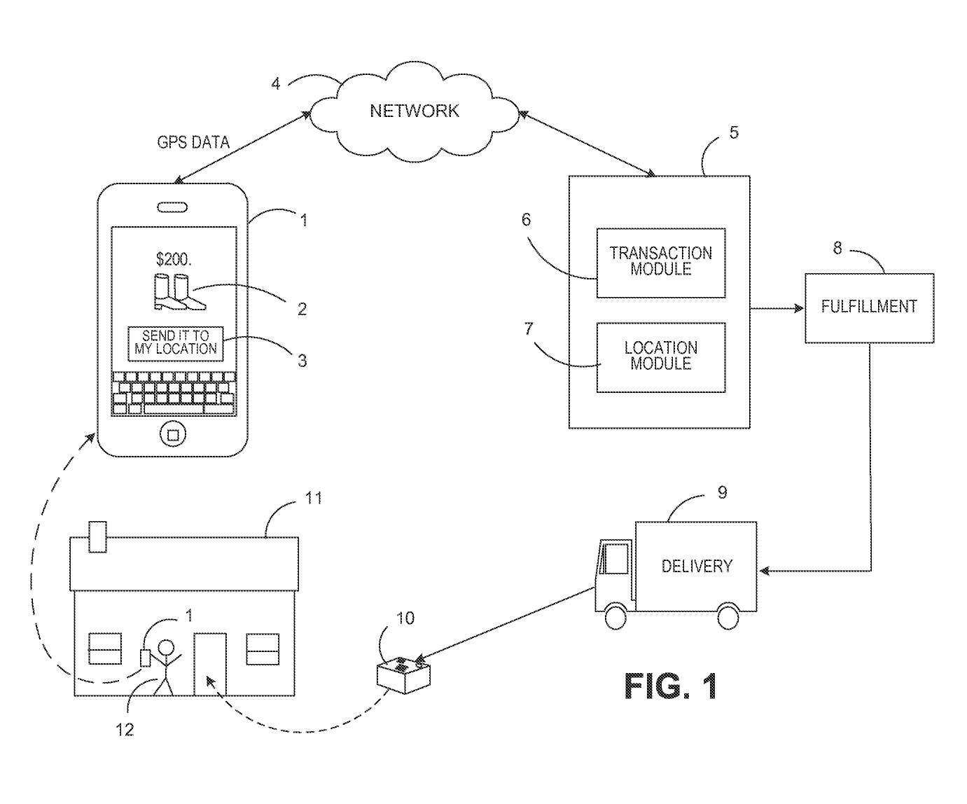

The components and operation of the enhanced system are depicted in FIG. 1. A user 12 seeks to perform on on-line transaction on his mobile device 1. Mobile device 1 is equipped with location detection capability, preferably GPS. Mobile device 1 may be could be a standard smart phone or a tablet, running on iOS or Android operating systems. The user 12 uses the mobile device 1 to connect to a transaction server 5 via a network 4. Network 4 is preferably the Internet, and transaction server 5 hosts an interactive website that allows transactions. Transactions are processed in the transaction module 6 of the transaction server 5. The transaction module 6 includes a database including for storing transaction data and customer data.

For purposes of this description, an exemplary transaction involving the sale and delivery of a piece of merchandise is shown. However, a the method and system are intended to encompass any situation in which a user's location information needs to be entered for a transaction. For example, the transaction could involve providing services, or the user's physical address may be needed for billing purposes.

On the website provided by the transaction server 5, a potential transaction for the user 12 to purchase some merchandise items 2 is displayed. Pursuant to this particular transaction, the items 2 need to be physically shipped to the user 12. In a conventional system, a user can be presented with a series of fields in which a shipping address can be manually entered. Alternatively, the user 12 may have a preexisting account with shipping information already stored in the transaction module 6. In accordance with the enhanced method described herein, however, the user 12 is presented with a selectable option to have the item shipped to the user's current location. Such option can be presented as a clickable button 3 displayed on the transaction mobile web page.

If the user selects the “SEND IT TO MY LOCATION” button 3, the GPS location services on the mobile device 1 are activated and the GPS data is transmitted over the network 4 to the location module 7 of the transaction server 5. Location module 7 then performs a reverse-geocoding operation on the location coordinates to determine a relevant address for the coordinates. In a preferred embodiment the location module 7 includes the Spectrum Location Intelligence platform or Geostan location intelligence platform, both available from Pitney Bowes Inc.

The address determined by the location module 7 can them be used by the transaction server operator's fulfillment system 8 for preparing the item 2 for delivery. A delivery service 9 then can then deliver the package 10 to the location 11 where the user 12 had clicked button 3.

Server 5 may be a mainframe or the like that is specially constructed for the required purposes, or it may comprise a general purpose computer selectively activated or reconfigured by a computer program (described further below) stored therein. Such a computer program may alternatively be stored in a computer readable storage medium, such as, but not limited to, any type of disk including floppy disks, optical disks, CD-ROMs, and magnetic-optical disks, read-only memories (ROMs), random access memories (RAMS), EPROMs, EEPROMs, magnetic or optical cards, or any type of media suitable for storing electronic instructions, which are executable by a processing device within the server 5. One of ordinary skill in the art would be familiar with the general components of a server system upon which the method of the present invention may be performed. It should also be understood that server 5 can be virtually distributed among multiple computers, and that such computers may also have multiple processors, as is conventionally known in the art.

Server 5 is in electronic communication with a transaction database associated with the transaction module 7. The transaction database stores information including, for example and without limitation, data relating to items and services for sale, customer information, data related to previous sale and shipments, and any such data that would normally be used for on-line transactions. Transaction data can further include, for example, product description, size, weight, and other shipping requirements.

Server 5 can be operated by or on behalf of a seller of goods (hereinafter referred to as the seller server). Server 5 may be capable of hosting a website for one or more sellers. One of ordinary skill in the art would be familiar with the general components of a server system upon which a website may be hosted. Websites being hosted by the server 5 can be accessed via the network 4 by a user 12 using a mobile device 1. It should be understood that the number of servers 5 and mobile devices 1 are not limited in number, and any number can be connected to the network 4.

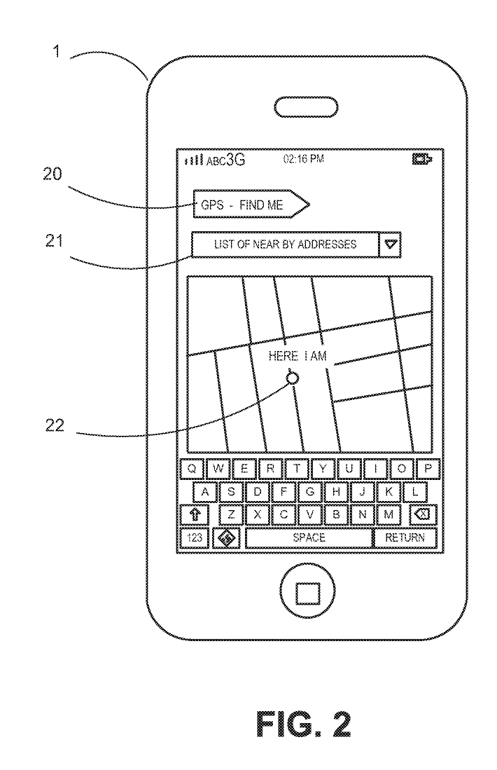

FIG. 2 depicts an alternate embodiment for enhancing the functionality of the location button 3. In this embodiment, the user selects the “SEND IT TO MY LOCATION” function an additional interactive interface is presented. The user 12 can select a further “FIND ME” button to activate a list 21 of potential addresses, and a map 22, to assist the user 12 in ensuring that a correct location is provided pursuant to this option. Address list 21 is a list of the closest addresses to the GPS coordinates, as determined by the reverse-geocoding functionality of the location module 7. The user 12 can confirm the correct address by clicking on the address from the list 21.

Map 22 shows the location of one or more potential addresses relevant to the coordinates. The context of seeing streets, buildings, and other landmarks on the map 22 can further assist the user 12 in determining and confirming the identification of the current address location to which the transaction is directed.

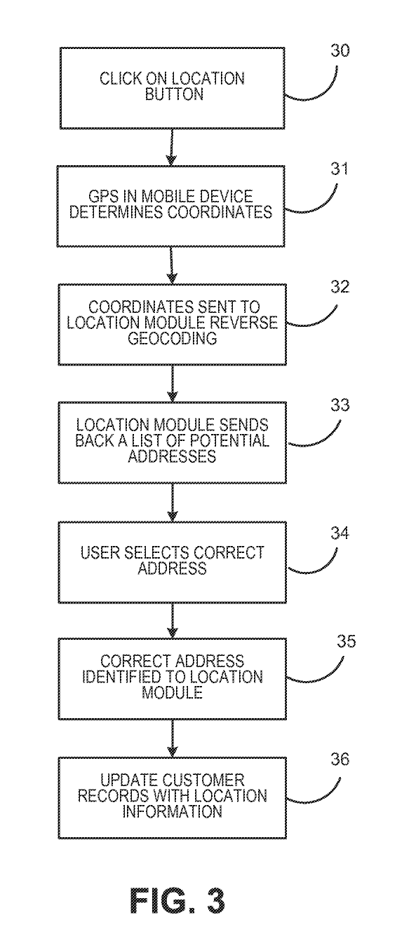

FIG. 3 provides an exemplary process flow for the enhanced system and method described herein. In step 30 a user 12 clicks the location button 3. The GPS of the mobile device 1 determines the coordinates of the user's present location (step 31). The coordinates are sent, via network 4, to the location module 7 of the transaction server 5 (step 32). The location module 7 determines a list of potential matching addresses and sends them back to be displayed on mobile device 1 (step 33). The user 12 selects the correct address to be used for the transaction (step 34). The selected correct address for the location is then provided back to the location module 7 (step 35). In step 36, customer records are updated to associate the selected location with the customer.

In addition to using the user confirmation for the current transaction, this information could also be used as an additional data-point for the location module to use in other location applications. For example, the user might be located in a place where location data in location module 7 is incomplete or out of date. The user's input could be used to supplement the existing records, and the accumulated affect from a large number of user inputs could be a significant improvement to the location data might be used for any location purposes.

Although the invention has been described with respect to preferred embodiments thereof, it will be understood by those skilled in the art that the foregoing and various other changes omissions and deviations in the form and detail thereof may be made without departing from the spirit and scope of this invention.

What is claimed is:

1. A method for using location data at a server computer to facilitate an electronic transaction performed over a computer network, the method comprising:
transmitting transaction information over a network to a remote device having location detection capability, the step of transmitting transaction information further including a message prompting a user to enter the user's location information, the step of prompting further including providing an option for the user to select automatically populating the location information from the device's location detection capability;
upon selection of the option to automatically populate location information by the user, receiving location coordinates at the server from the remote device;
reverse geocoding the received location coordinates to determine at least one matching address; and
entering the at least one matching address into a transaction database as an address relevant to the transaction.

2. The method of claim 1 wherein the transaction relates to delivery of goods to the user and the at least one matching address is a delivery address for the goods.

3. The method of claim 1 wherein the transaction relates to services to be performed and the at least one matching address is a location for the services to be performed.

4. The method of claim 1 further including a step of transmitting the at least one matching address to the remote device for user confirmation prior to entering it into the transaction database.

5. The method of claim 1 wherein the step of reverse geocoding results in more than one potentially matching address and further including steps of transmitting the more than one potentially matching addresses to the remote device for verification, receiving a verification indication of one of the potentially matching addresses from the remote device, and using the verified address for entry into the transaction database as the address relevant to the transaction.

6. The method of claim 5 further including a step of displaying the one or more potentially matching addresses on a map display to assist in verification.

7. The method of claim 5 further including a step of updating a general location database with the verified address information.

8. The method of claim further including a step of updating a database that includes the user's general profile to incorporate the at least one matching address.

9. A location intelligence computer system for using location data to facilitate an electronic transaction, the system comprising:
a server computer connected to a network and including a transaction database and configured to perform the following steps:
transmitting transaction information over the network to a remote device having location detection capability, the step of transmitting transaction information further including a message prompting a user to enter the user's location information, the step of prompting further including providing an option for the user to select automatically populating the location information from the device's location detection capability;
upon selection of the option to automatically populate location information by the user, receiving location coordinates at the server from the remote device;
reverse geocoding the received location coordinates to determine at least one matching address; and
entering the at least one matching address into the transaction database as an address relevant to the transaction.

10. The system of claim 9 wherein the transaction relates to delivery of goods to the user and the at least one matching address is a delivery address for the goods.

11. The system of claim 9 wherein the transaction relates to services to be performed and the at least one matching address is a location for the services to be performed.

12. The system of claim 9 wherein the server s further configured to include a step of transmitting the at least one matching address to the remote device for user confirmation prior to entering it into the transaction database.

13. The system of claim 9 wherein the server's configured step of reverse geocoding results in more than one potentially matching address and the server is further configured to include steps of transmitting the more than one potentially matching addresses to the remote device for verification, receiving a verification indication of one of the potentially matching addresses from the remote device, and using the verified address for entry into the transaction database as the address relevant to the transaction.

14. The system of claim 13 wherein the server is further configured to display the one or more potentially matching addresses on a map display to assist in verification.

15. The system of claim 13 wherein the server is further configured to update a general location database with the verified address information.

16. The system of claim 9 wherein the server is further configured to include a step of updating a database that includes the user's general profile to incorporate the at least one matching address.
